(19) United States
(12) Patent Application Publication
(10) Pub. No.: US 2004/0095512 A1
(43) Pub. Date: May 20, 2004

(54) Digital tv set

(76) Inventor: Hiroyuki Miyake, Hyogo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/473,162

(22) PCT Filed: Feb. 25, 2002
(86) PCT No.: PCT/JP02/01680

(30) Foreign Application Priority Data
Mar. 30, 2001 (JP) 2001-99506

(51) Int. Cl. H04N 5/44

(52) U.S. Cl. 348/725; 725/151

(57) ABSTRACT

An object of the present invention is to provide a digital television broadcasting receiver capable of transmitting internal time information as reference time information to an apparatus LAN-connected to the digital television broadcasting receiver. The digital television broadcasting receiver according to the present invention comprises means for transmitting, on the basis of a time information acquisition request from an apparatus LAN-connected to the digital television broadcasting receiver, internal time information as reference time information to the apparatus which has issued the time information acquisition request.

### TECHNICAL FIELD

The present invention relates to a digital television broadcasting receiver.

### BACKGROUND ART

In current digital television broadcasting receivers, a TCP/IP connection for a two-way communication function has been mainly defined as an option in order to advance data broadcasting. The TCP/IP connection is a connection type (stream type) communication protocol, and has a one-to-one relationship with a server client. Further, it is higher in reliability, as compared with a UDP (User Diagram Protocol) (connectionless type) protocol or the like, and is a virtual protocol on the today's Internet.

In digital television broadcasting receives up to the present, however, network communication in a TCP/IP protocol is directed only toward the outside of homes in the present conditions. It is not considered at all that the digital television broadcasting receiver is utilized as an NTP (Network Time Protocol) server (reference time server) in a home LAN (Local Area Network) or the like.

An object of the present invention is to provide a digital television broadcasting receiver capable of transmitting internal time information as reference time information to an apparatus LAN-connected to the digital television broadcasting receiver.

### DISCLOSURE OF INVENTION

A first digital television broadcasting receiver according to the present invention is characterized by comprising means for transmitting, on the basis of a time information acquisition request from an apparatus LAN-connected to the digital television broadcasting receiver, internal time information as reference time information to the apparatus which has issued the time information acquisition request.

A second digital television broadcasting receiver according to the present invention is characterized by comprising a circuit for transmitting, on the basis of a time information acquisition request from an apparatus LAN-connected to the digital television broadcasting receiver, internal time information as reference time information to the apparatus which has issued the time information acquisition request.

A third digital television broadcasting receiver according to the present invention is characterized by comprising means for broadcast-transmitting internal time information as reference time information at predetermined timing to all apparatuses LAN-connected to the digital television broadcasting receiver.

A fourth digital television broadcasting receiver according to the present invention is characterized by comprising a circuit for broadcast-transmitting internal time information as reference time information at predetermined timing to all apparatuses LAN-connected to the digital television broadcasting receiver.

According to the digital television broadcasting receiver in the present invention, the internal time information can be transmitted as the reference time information to the apparatus LAN-connected to the digital television broadcasting receiver.

### BRIEF DESCRIPTION OF DRAWINGS

FIG. 1 is a schematic view showing an example of a system configuration.

FIG. 2 is a flow chart showing the procedure for processing for producing internal time information in one second in a digital television broadcasting receiver for receiving digital BS broadcasting.

FIG. 3 is a flow chart showing operations in a case where internal time information held by a digital television broadcasting receiver 10 is acquired by a PC 1 using a first method.

### BEST MODE FOR CARRYING OUT THE INVENTION

Referring now to the drawings, an embodiment of the present invention will be described.

[1] Description of system configuration

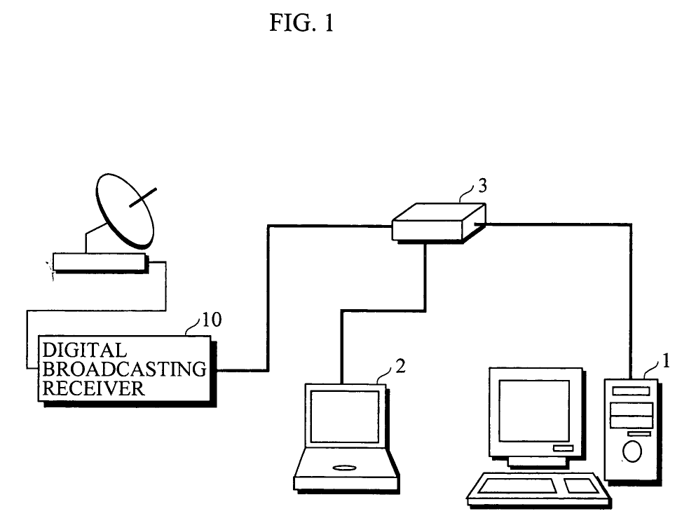

FIG. 1 illustrates a network system constructed by connecting a digital television broadcasting receiver and a PC (Personal Computer) through a home LAN.

In FIG. 1, a digital television broadcasting receiver 10, a PC 1, and a PC 2 are connected to one another through a network hub 3. In such a network configuration, a host name/network address, etc. are required in order to identify each of apparatuses.

In this example, the following network addresses are assigned to the digital television broadcasting receiver, the PC1, and the PC 2:

| | |
|---|---|
| Digital broadcasting receiver | 192.168.1.250 |
| PC1 | 192.168.1.1 |
| PC2 | 192.168.1.2 |

The present embodiment is characterized in that the digital television broadcasting receiver can be utilized as an NTP server (reference time server) for providing reference time information to the other apparatuses.

[2] Description of internal time information in digital television broadcasting receiver

In digital television broadcasting, time information is sent out by a broadcasting wave. For example, time information is sent out by a TOT (Time Offset Table) in the case of digital BS broadcasting, a TDT (Time Data Table) in CS (124/128) digital broadcasting, and either one of the TOT and the TDT in 110CS broadcasting.

The digital television broadcasting receiver produces internal time information using the time information sent by the broadcasting wave as a reference, to realize various types of functions (reservation execution/program name display at the time of switching programs) on the basis of the internal time information. However, the sending of the time information by the broadcasting wave is not necessarily stable. The updating period is not one second. In the current broadcasting standard, it is determined that one or more time information are sent out per approximately 30 seconds.

Therefore, a lot of receivers produce a time period in one second by time information most newly acquired from the broadcasting wave and an internal timer also in consideration of cases such as a case where no broadcasting wave can be acquired at the time of receiving obstruction.

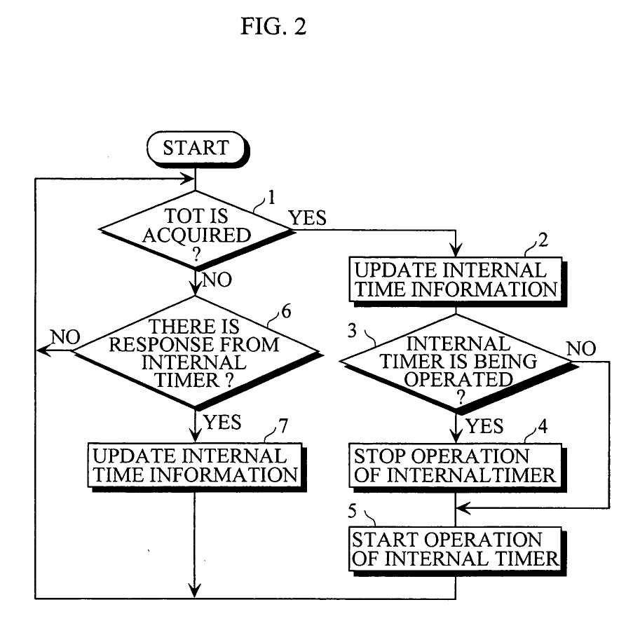

FIG. 2 shows the procedure for processing for producing internal time information in one second in a digital television broadcasting receiver for receiving digital BS broadcasting.

The digital television broadcasting receiver performs a channel selection operation with respect to a channel finally tuned in to by a user from the time when the receiver is started (the power thereto is turned on) or a default channel determined by a program. In the step of acquiring various types of information from a broadcasting wave after completion of the channel selection, time information shall be also similarly acquired, and the processing for the acquisition shall be continuously performed.

In the digital television broadcasting receiver, when a tuner is locked, a TOT section is filtered in a DEMUX (Demultiplexing) circuit.

Therefore, it is judged whether or not the TOT is acquired every predetermined time intervals (step 1). When the TOT is acquired, internal time information is updated on the basis of time information inside the acquired TOT (step 2). It is judged whether or not an internal timer which makes a response for each second is being operated (step 3). When the internal timer is being operated, the operation of the internal timer is stopped once (step 4), and the operation of the internal timer is then started (step 5). The procedure is then returned to the step 1.

When the internal timer stops being operated in the foregoing step 3, the operation of the internal timer is started (step 5). The procedure is then returned to the step 1.

It is judged in the foregoing step 1 that the TOT is not acquired, it is judged whether or not there is a response (a response produced for each second) from the internal timer (step 6). If there is no response from the internal timer, the procedure is returned to the step 1. If there is a response from the internal timer, the internal time information is updated to a value set one second ahead (step 7) , after which the procedure is returned to the step 1.

[3] Description of operations in case where digital television broadcasting receiver is utilized as NTP server (reference time server)

Description is now made of a case where internal time information held by the digital television broadcasting receiver 10 is acquired by the PC 1.

The following two methods are known as a method of acquiring in the PC 1 the internal time information held by the digital television broadcasting receiver 10.

(1) First method: Method of issuing a request to the digital television broadcasting receiver 10 from the PC 1 and receiving the request

(2) Second method: Method of receiving in the PC 1a broadcast message periodically produced by the digital television broadcasting receiver 10 in a network

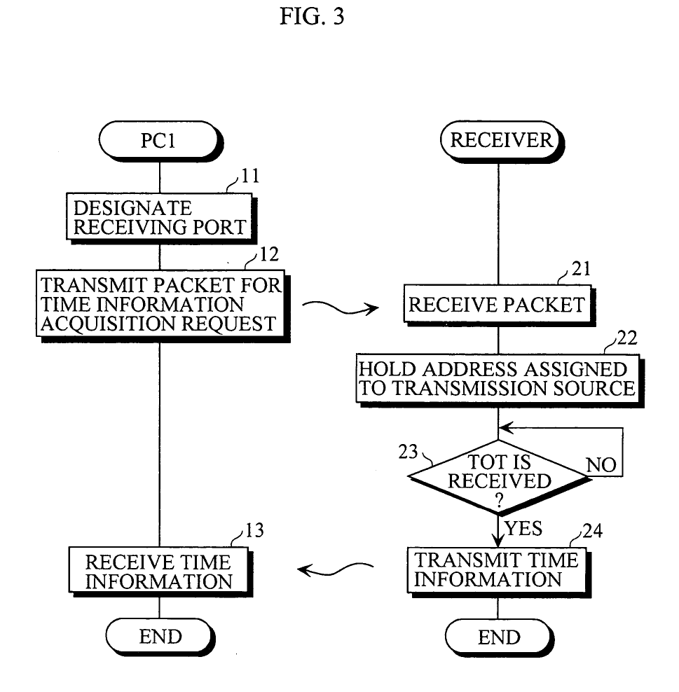

FIG. 3 shows operations in a case where the internal time information held by the digital television broadcasting receiver 10 is acquired by the PC 1 using the first method.

The PC 1 first designates a receiving port (step 11), and then transmits a packet for a time information acquisition request to the digital television broadcasting receiver 10 (address: 192.168.1.250) (step 12).

The digital television broadcasting receiver 10 temporarily holds, when it receives the packet for the time information acquisition request from the PC 1 (step 21), an address (192.168.1.1) assigned to a transmission source (PC1) of the packet (step 22).

Thereafter, the digital television broadcasting receiver 10 transmits, when it receives the TOT from the broadcasting wave (step 23), time information inside the received TOT to the address held in the step 22 (the address assigned to the PC 1) (step 24).

The PC 1 receives the time information transmitted from the digital television broadcasting receiver 10 (step 13). In such a way, the PC 1 can acquire the time information from the digital television broadcasting receiver 10.

In the case of the second method, the digital television broadcasting receiver 10 transmits, when it receives the TOT from the broadcasting wave, for example, the time information inside the received TOT to all clients in the network. Each of the clients may receive the time information.

As to broadcast transmission of the time information, an effect to others is not easily considered in the case of a configuration using a private (home) LAN. Therefore, it is considered that there is no problem even if the broadcast transmission is made at the timing of receiving the time information in the broadcasting wave. However, it cannot be positively said that there is no effect in cases such as a case where another NTP server exists inside the private LAN, and provides the time information to the outside of the private LAN. Therefore, it is preferable that in setting the receiver, the user can set judgment whether or not broadcast transmission of the time information is made (whether the time information is periodically sent out via the network and/or a response is made only at the time of a request).

Meanwhile, the opportunity to individually access an NTP server, to correct a PC internal clock is being increased by the existing PC society conditions and improvement of always-on connection. Even if access to an external NTP server is allowed, however, legal questions are left unanswered in utilization of the server when the server is not “public”.

Furthermore, with respect to a server which is public, the Internet is also utilized, and its path and the operating conditions of the server are not necessarily assured. Further, with respect to a PC which is not in an environment such as always-on connection, a fee for access is charged. Utilization of the digital television broadcasting receiver as a home NTP server, which can stably acquire accurate time in all parts of the country, is considered to be one of effective means when future complicated coordination with other home apparatuses is considered.

1. A digital television broadcasting receiver comprising:
means for transmitting, on the basis of a time information acquisition request from an apparatus LAN-connected to the digital television broadcasting receiver, internal time information as reference time information to the apparatus which has issued the time information acquisition request.

2. A digital television broadcasting receiver comprising:
a circuit for transmitting, on the basis of a time information acquisition request from an apparatus LAN-connected to the digital television broadcasting receiver, internal time information as reference time information to the apparatus which has issued the time information acquisition request.

3. A digital television broadcasting receiver comprising:
means for broadcast-transmitting internal time information as reference time information at predetermined timing to all apparatuses LAN-connected to the digital television broadcasting receiver.

4. A digital television broadcasting receiver comprising:
a circuit for broadcast-transmitting internal time information as reference time information at predetermined timing to all apparatuses LAN-connected to the digital television broadcasting receiver.
